(19) United States
(12) Patent Application Publication
(10) Pub. No.: US 2017/0337116 A1
(43) Pub. Date: Nov. 23, 2017

(54) APPLICATION TESTING ON DIFFERENT DEVICE TYPES

(71) Applicant: Google Inc., Mountain View, CA (US)

(72) Inventors: Stanislav Negara, Mountain View, CA (US); Ahmed Mounir Gad, Berkeley, CA (US); Justin William Sinclair Broughton, Mountain View, CA (US)

(21) Appl. No.: 15/158,453

(22) Filed: May 18, 2016

(51) Int. Cl. G06F 11/36

(52) U.S. Cl. CPC G06F 11/3664; G06F 11/3636; G06F 11/3688

(57) ABSTRACT

Methods, systems, and apparatus include computer programs encoded on a computer-readable storage medium, including a p_method for testing applications. A connection is made by a test development device to a source device. User interactions with various components of an application executing at the source device are detected by the test development device. A p_method corresponding to each user interaction with the various components of the application is identified by the test development device and within code of the application or underlying OS framework code. Contextual information is extracted from each identified p_method that corresponding to the component with which the user interaction occurred. A test script is generated by the test development device based on the user interactions and the contextual information extracted from the identified p_methods. The test script is automatically run on a test device that differs from the source device.

### BACKGROUND

This specification relates to application development and testing.

Applications that are written for use on computing devices, including mobile devices, are often tested before being released for use. The applications may be provided for use, for example, on several different types of devices.

Some testing of new and existing applications can be done using debuggers. For example, a debugger can allow a tester to set break points, examine variables, set watches on variables, and perform other actions.

### SUMMARY

In general, one innovative aspect of the subject matter described in this specification can be implemented in methods that include connecting, by a test development device, to a source device; detecting, by the test development device, user interactions with various components of an application executing at the source device; identifying, by the test development device and within code of the application or underlying OS framework code, a p_method corresponding to each user interaction with the various components of the application; extracting, from each identified p_method, contextual information corresponding to the component with which the user interaction occurred; generating, by the test development device, a test script based on the user interactions and the contextual information extracted from the identified p_methods; and automatically running the test script on a test device that differs from the source device.

These and other implementations can each optionally include one or more of the following features. Connecting to the source device can include connecting to a mobile device that is executing a mobile application. The method can further include identifying, within the code of the application or OS framework, a target p_method corresponding to a target user interaction to be tracked; identifying a first line of the target p_method within the code of the application or OS framework; and inserting a line breakpoint into the code of the target p_method based on the identified first line of the target p_method. Identifying a p_method corresponding to each user interaction with the various components of the application can include processing the line breakpoint during execution of the application at the source device. Extracting contextual information can include extracting, after processing the line breakpoint, one or more attributes of the target p_method. The method can further include providing, on a display of the test development device, a test simulation display that replicates and simulates testing on a user interface of the source device; and presenting, within the test simulation display, the user interactions with the various components of the application. The method can further include presenting, within the test simulation display, a list of the user interactions with the various components of the application, wherein the list of user interactions is generated based on the test script.

In general, another aspect of the subject matter described in this specification can be implemented a non-transitory computer storage medium encoded with a computer program. The program can include instructions that when executed by a distributed computing system cause the distributed computing system to perform operations including connecting, by a test development device, to a source device; detecting, by the test development device, user interactions with various components of an application executing at the source device; identifying, by the test development device and within code of the application or underlying OS framework code, a p_method corresponding to each user interaction with the various components of the application; extracting, from each identified p_method, contextual information corresponding to the component with which the user interaction occurred; generating, by the test development device, a test script based on the user interactions and the contextual information extracted from the identified p_methods; and automatically running the test script on a test device that differs from the source device.

These and other implementations can each optionally include one or more of the following features. Connecting to the source device can include connecting to a mobile device that is executing a mobile application. The operations can further include identifying, within the code of the application or OS framework, a target p_method corresponding to a target user interaction to be tracked; identifying a first line of the target p_method within the code of the application or OS framework; and inserting a line breakpoint into the code of the target p_method based on the identified first line of the target p_method. Identifying a p_method corresponding to each user interaction with the various components of the application can include processing the line breakpoint during execution of the application at the source device. Extracting contextual information can include extracting, after processing the line breakpoint, one or more attributes of the target p_method. The operations can further include providing, on a display of the test development device, a test simulation display that replicates and simulates testing on a user interface of the source device; and presenting, within the test simulation display, the user interactions with the various components of the application. The operations can further include presenting, within the test simulation display, a list of the user interactions with the various components of the application, wherein the list of user interactions is generated based on the test script.

In general, another aspect of the subject matter described in this specification can be implemented in systems that include one or more processing devices and one or more storage devices. The storage devices store instructions that, when executed by the one or more processing devices, cause the one or more processing devices to connect, by a test development device, to a source device; detect, by the test development device, user interactions with various components of an application executing at the source device; identify, by the test development device and within code of the application or underlying OS framework code, a p_method corresponding to each user interaction with the various components of the application; extract, from each identified p_method, contextual information corresponding to the component with which the user interaction occurred; generate, by the test development device, a test script based on the user interactions and the contextual information extracted from the identified p_methods; and automatically run the test script on a test device that differs from the source device.

These and other implementations can each optionally include one or more of the following features. Connecting to the source device can include connecting to a mobile device that is executing a mobile application. The system can further include instructions that cause the one or more processors to identify, within the code of the application or OS framework, a target p_method corresponding to a target user interaction to be tracked; identify a first line of the target p_method within the code of the application or OS framework; and insert a line breakpoint into the code of the target p_method based on the identified first line of the target p_method. Identifying a p_method corresponding to each user interaction with the various components of the application can include processing the line breakpoint during execution of the application at the source device. Extracting contextual information can include extracting, after processing the line breakpoint, one or more attributes of the target p_method. The system can further include instructions that cause the one or more processors to provide, on a display of the test development device, a test simulation display that replicates and simulates testing on a user interface of the source device; and present, within the test simulation display, the user interactions with the various components of the application.

Particular implementations may realize none, one or more of the following advantages. A user testing a device can interact with the device normally (e.g., hold a mobile phone and use an application), and all user interactions can be captured automatically for automatic generation of a test script. During testing, the user interactions and associated contextual information can be recorded using features of the debugger while being device and operating system (OS) version (API level) agnostic. Testing and test script generation can be done without requiring any code changes to the tested application or the OS image. Creation of test cases can be simplified for testing across multiple device types. For example, an application can be manually tested on a single device, the user interactions performed during the manual testing can be recorded and used to automatically generate a test script, and the resulting test script can be used to automatically test other devices independent of user interaction with those other test devices. User interactions and corresponding contextual information for an application being tested can be recorded in a consistent and reliable way, and the resulting test script can emulate the user interactions that occurred during the manual test. Test scripts can be generated for applications without requiring a user who is generating the test script to code the test script.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example test environment for testing a source device and generating a test script for testing plural test devices.

FIG. 2 shows a detailed view of a test development device that records user interactions during user interaction with a source device.

FIG. 3 shows another view of the test development device in which a test script is displayed.

FIG. 4 shows another view of the test development device in which a test script launcher is displayed.

FIG. 5 is a flowchart of an example process for generating, by a test development device, a test script using user interactions and contextual information identified from a source device being tested.

FIG. 6 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for capturing user interactions and contextual information while testing an application on a source device and automatically generating a test script for automatically testing other devices based on user interactions with the application during the testing. For example, the application can be run in debug mode, and user interactions can be recorded while testing an application running on a mobile device (e.g., through manual interaction with application at the mobile device). Using the recorded interactions, a corresponding instrumentation test case (e.g., using Espresso or another testing application programming interface (API)) can be generated that can be run on any number of physical and/or virtual devices. In this way, a debugger-based approach can be used to record the user interactions and collect all necessary information for the test case generation.

Debugger-based recording can, for example, provide reliable recording of user interactions as well as contextual information associated with each of the user interactions across various device types and/or operating systems. For example, each user interaction generally corresponds to a method breakpoint. Therefore, breakpoints for user interactions can be defined as method breakpoints in order to identify the locations of the methods corresponding to the user interactions. Once the locations of the methods are identified, the method breakpoints are translated into line breakpoints, which are used to record the user interactions and the contextual data associated with each of the user interactions. As such, the locations of the line breakpoints are dynamically determined when the application is launched.

Line breakpoints generally have less of an effect on the responsiveness of the application than method breakpoints. As such, translation of the method breakpoints into line breakpoints enables the use of breakpoints to collect user interactions and corresponding contextual information across various devices and/or various operating systems without experiencing the lag that is caused when using method breakpoints.

The ability to record user interactions across various devices and operating systems facilitates the generation of test scripts that can be used to automatically test an application on various devices. For example, a user can interact with an application executing at a mobile device, and those interactions can be recorded and automatically used to generate a test script that can be executed across a wide range of devices and operating systems.

In some implementations, fully reusable test cases (e.g., test scripts) can be created and used. For example, using an extended version of a debugger connected to a source device being tested, a user can start a recorder (e.g., within a debugger or application development environment) which launches a given application (e.g., an application being tested) on any selected device. The user can then use the given application normally, and the recorder can capture all user inputs into the application and generate a reusable test script using the captured user inputs.

For every user interaction to be recorded, one or more locations (e.g., specific lines in the code) can be identified in the application and/or OS framework (e.g., Android framework) code that handles the interaction. For each interaction/location, the application being tested can be run in debug mode, and breakpoints can be set for the locations of interest. For example, the breakpoints can be determined by identifying a first line number of a particular programmed method (“p_method”) from the Java Virtual Machine (JVM) code on the device being tested. In some implementations, each breakpoint can be defined as a class#method to avoid hardcoding line breakpoints, which are API level specific. Then, method breakpoints can be translated into line breakpoints on a given device/API level to prevent latency issues associated with using method breakpoints. For example, a Java Debug Interface (JDI) API can be used to convert the method breakpoint to be a first line breakpoint of the corresponding method on a given device. As used throughout this document the phrases “programmed method” or “p_method” refer to a programmed procedure that is defined as part of a class and included in any object of that class.

Whenever a breakpoint is hit during user interaction with the application, relevant information associated with the user interaction can be collected from the debug context in order to generate a portion of a test script (e.g., an Espresso statement) for replicating the recorded user interaction. After collecting the debug context, the debug process can resume immediately and automatically. For example, for a click event on a view widget, a breakpoint can be set on the first line of the p_method that handles the click event on view widget. When the breakpoint is reached, for example, the kind of event (e.g., View click) can be recorded along with a timestamp, a class of the affected element, and any available identifying information, e.g., the element's resource name, text, and content description. For example, text input by the user can be captured, or the user's selection (e.g., by a mouse click) from a control providing multiple options can be recorded. Other user interactions can be captured. Identifying information can also be recorded for a capped hierarchy of the affected element's parents.

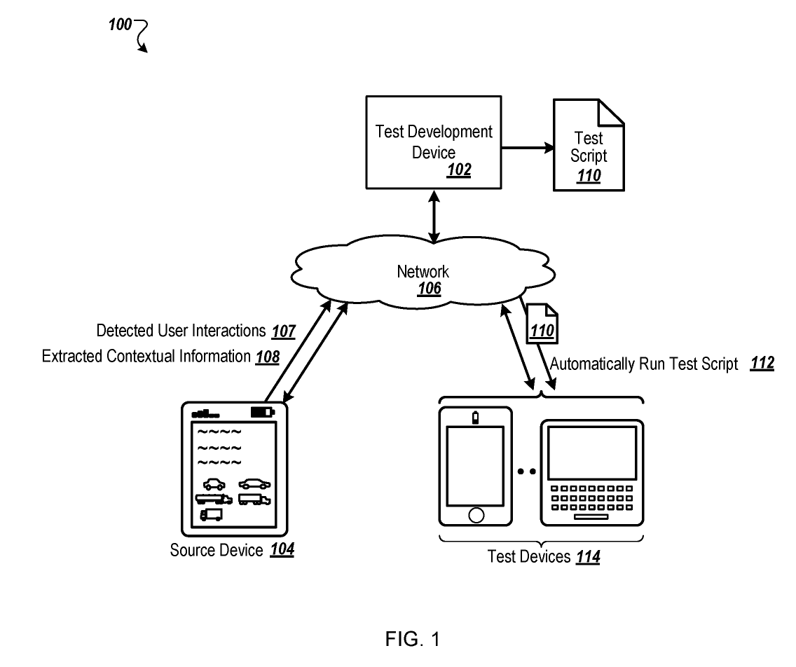

FIG. 1 is a block diagram of an example test environment 100 for testing a source device and generating a test script for testing plural test devices. For example, a test development device 102 can be connected to a source device 104, such as through a cable or through a network 106. The test development device 102 can include hardware and software that provide capabilities of a debugger for debugging applications, capabilities of an interaction recorder for recording user interactions, and/or capabilities of a test script generator for automatically generating test scripts based on the recorded user interactions. The test development device 102 can be, for example, a single device or system that includes multiple different devices. In some implementations, capabilities of the test development device 102 can be distributed over multiple devices and/or systems, including at different locations. For example, each of the capabilities of the test development device could be implemented in a separate computing device.

As used throughout this document, the phrase “source device” refers to a device from which user interaction information is obtained by the test development device. The source device 104, for example, can be a physical device (e.g., local to or remote from the test development device 102) or an emulated device (e.g., through a virtual simulator) that is being tested and at which user interactions are being recorded. The source device 104 can be a mobile device, such as a particular model of a mobile phone, or some other computer device. In some implementations, the test development device 102 can record user interactions with the source device 104 and automatically generate a test script that can be used to automatically test plural test devices 114 based on the recorded user interactions.

During testing of an application executing on the source device 104, for example, the test development device 102 can identify user interactions with various components of the application for which detected user interactions 107 and extracted contextual information 108 are to be obtained. The components, for example, can correspond to software components that handle user interactions such as keyboard or text input, mouse clicks, drags, swipes, pinches, keyboard input, use of peripherals, and other actions. The test development device 102 can identify, within code of the application or underlying OS framework code for example, a p_method corresponding to each user interaction with the various components of the application. In some implementations, identification can be made when the test development device 102 is initiated for testing the source device 104, e.g., based on a list of p_methods that are to be monitored for user interactions. For example, when the test development device 102 launches an application, a list of user interactions (e.g., clicking, text input, etc.) can be identified, such as along the lines of “identify the p_method associated with each of the user interactions Tap, Text, etc.” It is at the first lines (or other specified locations) of these p_methods, for example, that user interaction and contextual information is to be obtained (e.g., based on processing of a breakpoint that has been dynamically inserted into the application code or underlying OS framework code by the test development device 102).

During testing of the source device 104, for example, the test development device 102 can extract, for each identified p_method, contextual information corresponding to the component with which the user interaction occurred. For example, if the user interaction is text input, then the contextual information can include the text character(s) entered by the user, the name of a variable or field, and other contextual information. Other contextual information can include, a selection from a list or other structure, a key-press (e.g., including combinations of key presses), a duration of an action, and an audible input, to name a few examples. Using the extracted information, for example, the test development device 102 can generate a test script 110 that is based on the user interactions and the contextual information extracted from the identified p_methods.

In some implementations, the generated test script can be automatically run (112) to test one or more other devices, such as the test devices 114. For example, once the test script 110 is created, a user testing the application can select from one or more other test devices 114 on which to run the test script 110. In some implementations, the test environment 100 can be configured to automatically run the test on a pre-defined list of test devices 114 and/or other test scenarios. In some implementations, the test environment 100 can be configured to run regression tests on a pre-defined list of test devices 114, such as after a software change has been made to an application.

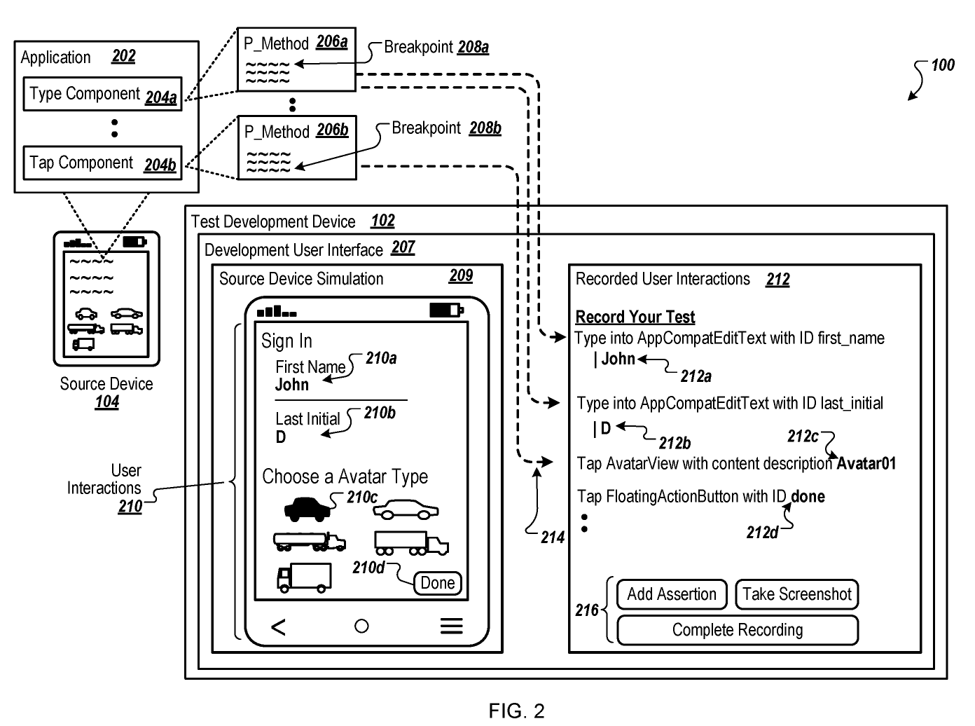

FIG. 2 shows a detailed view of the test development device 102 that records user interactions during user interaction with a source device 104 (e.g., during a test of an application executing on the source device 104). For example, an application 202 executing on the source device 104 is being tested through user interaction with the source device 104, and the portion of the test that is shown includes a login sequence and a selection of an image. The application 202 includes a type component 204a and a tap component 204b. The components 204a and 204b can correspond, respectively, to text input and mouse click user interactions that occur during testing of the application 202. In addition to components 204a and 204b, there can be other components (not shown in FIG. 2) that correspond to other types of user interactions (e.g., swipe, etc.). For each of the components 204a and 204b, for example, corresponding p_methods 206a and 206b can be identified by the test development device 102. For example, the test development device 102 can identify, within code of the application or underlying OS framework, a p_method corresponding to each user interaction with the various components of the application. For example, the p_methods 206a and 206b are the underlying software components that perform and/or handle the actual user interactions. As such, the test development device 102 can set breakpoints 208a and 208b, respectively, in the p_methods in order to capture contextual information whenever the breakpoints are reached. In this way, the test development device 102 can detect user interactions with various components of the application 202 executing at the source device 104.

As a test of the application 202 is run, the test development device 102 can extract contextual information from each identified p_method (e.g., including p_methods 206a and 206b) corresponding to the component with which a user interaction has occurred. During execution of the test, a development user interface 207 of the test development device 102 can present a source device simulation 209. For example, user interactions 210 can be simulated (e.g., presented as a visualization in a display) in the source device simulation 209 as the user interactions occur on the source device 104. As screens and displays change on the source device 104, the source device simulation 209 can also change in a similar way to provide a visual representation of the user interface that is presented at the source device. For example, a type user interaction 210a (that actually occurs on the source device 104) can be used to simulate user input of a first name “John” into a first name field on the source device simulation 209. A type user interaction 210b, for example, can simulate user input of a last initial “D” into a last initial field. The type user interactions 210a and 210b, for example, can correspond to the type component 204a associated with text input (e.g., typed-in data). A tap user interaction 210c, for example, can correspond to the tap component 204b, e.g., under which the user has clicked (using a mouse, stylus, or in another way) a specific selection. In general, user interactions can include tap (e.g., button/option selections, scrolling), text input, key-presses (e.g., enter, back/forward, up/down, escape), assertions, swipes, zooms, and other actions. In some implementations, the test development device 102 can include or be integrated with a screen streaming tool, e.g., for streaming information presented on the source device 104.

The development user interface 207 can include a recorded user interactions area 212 that can provide, for example, a presentation of a plain English (or another language) summary of the user interactions 210. For example, recorded user interactions 212a, 212b and 212c can correspond to the user interactions 210a, 210b and 210c, respectively, presented in source device simulation 209. As shown by arrows 214, the recorded user interactions 212a, 212b and 212c are generated from corresponding ones of the breakpoints 208a and 208b. In another example, recorded user interaction 212d corresponds to user interaction 210d, e.g., user clicking a “Done” button that was presented in the user interface of the source device 104. The development user interface 207 can include various controls 216 that can be used (e.g., through user interaction) to control a debugging session, recording of user interactions, and generation of the test script, including enabling a user to add assertions, take screenshots (e.g., of the source device simulation 209) start and stop recording of a test script, and perform other actions.

Assertions, for example, can be used to verify that the state of an application conforms to required results, e.g., that a user interface operates and/or responds as expected. Assertions can be added to a test script, for example, to assure that expected inputs are received (e.g., a correct answer is given on a multiple choice question, or a particular checkbox is checked), or that a particular object (e.g., text) is showing on a page. Assertions can be added using the various controls 216 or in other ways.

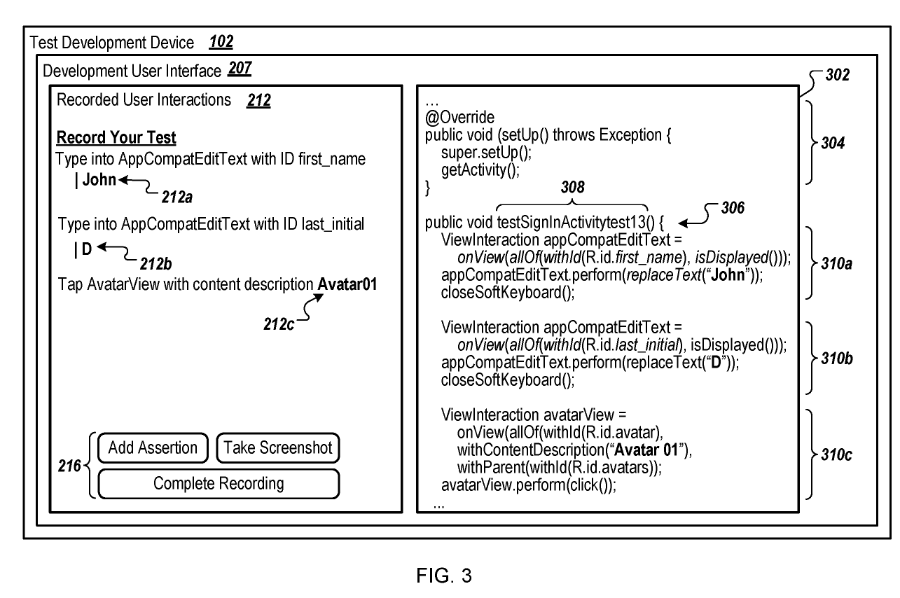

FIG. 3 shows another view of the test development device 102 in which a test script 302 is displayed. In some implementations, the test script 302 can be generated in Espresso or some other user interface test script language. The test development device 102 can generate the test script 302 based on the user interactions 210 that occur during testing of the application 202 on the source device 104. For example, entries in the test script 302 can correspond to user interactions shown in the recorded user interactions area 212.

The test script 302 can include generic and/or header information 304 that is independent of tested user actions, such as lines in the test script that allow the test script to run properly and prepare for the lines in the test script that are related to user interactions. A test script name 306, for example, can be used to distinguish the test script 302 from other test scripts, such as for user selection (and/or automatic selection) of a test script to be used to test various test devices 114. Entries can exist in (or be added to) the test script 302, for example, whenever a breakpoint is reached (e.g., the breakpoints 208a and 208b for p_methods 206a and 206b of the components 204a and 204b, respectively). For example, test script portions 310a, 310b and 310c of the test script 302 can be automatically generated by the test development device 102 upon the occurrence of the user interactions 210a, 210b and 210c, respectively. The test script portions 310a, 310b and 310c can be written to the test script 310, for example, upon hitting corresponding ones of the breakpoints 208a and 208b.

In some implementations, the source device simulation 209 can include controls by which a testing user can initiate testing on the source device 104 or on some other device not local to the user but available through the network 206. For example, instead of being a presentation-only display of user interactions, the source device simulation 209 can also receive user inputs for a device being tested.

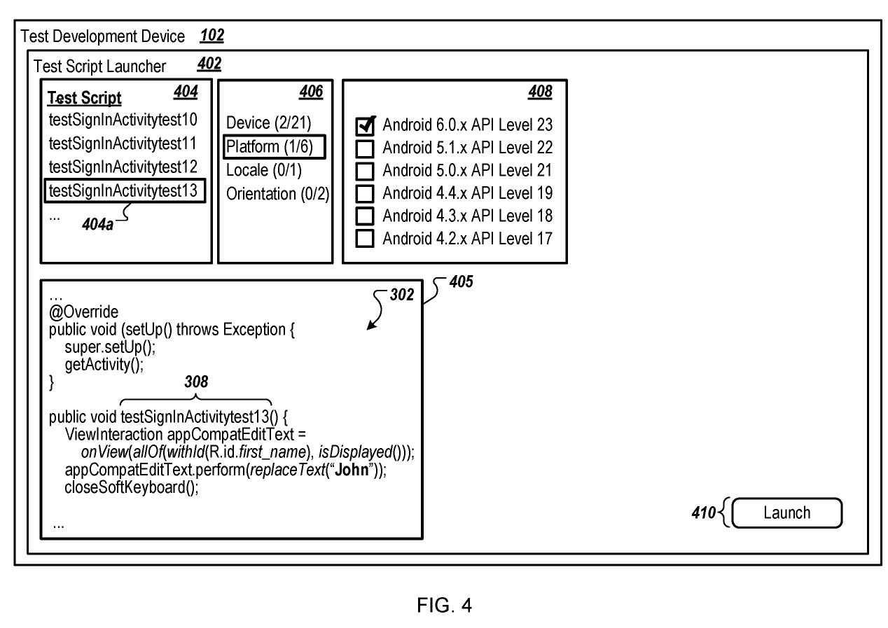

FIG. 4 shows another view of the test development device 102 in which a test script launcher 402 is displayed. The test script launcher 402 can be used, for example, to launch a recorded test script, such as the test script 302, in order to test one or more test devices 114. In some implementations, the test script launcher 402 can exist outside of the test development device 102, such as in a separate user interface.

In some implementations, to select a test script to be launched, a test script selection 404a can be selected from a test script list 404. In some implementations, selection of the test script can cause lines of the test script to be displayed in a test script area 405. As shown, test script name “testSignInActivityl3” in the test script selection 404a matches the test script name 308 of the test script 302 described with reference to FIG. 3.

The test script launcher 402 includes a device/platform selection area 406 and an operating system version selection area 408. Selections in the areas 406 and 408 can identify devices and/or corresponding operating systems on which the test script 302 is to be run. A launch control 410, for example, can initiate the automated testing of the specified devices and/or operating systems using the test script 302, which was automatically generated, for example, using the recorded user interactions, as discussed above.

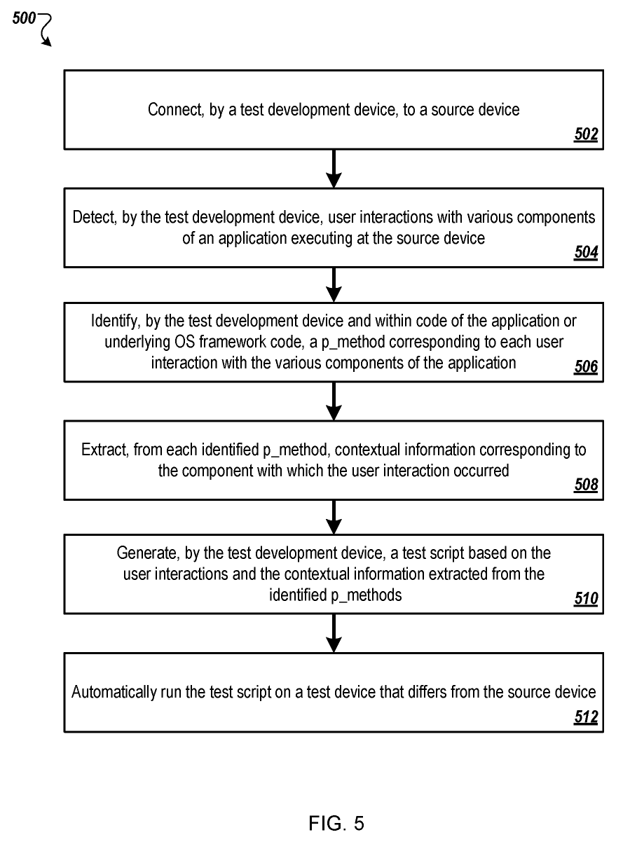

FIG. 5 is a flowchart of an example process 500 for generating, by a test development device, a test script using user interactions and contextual information identified from a source device being tested. FIGS. 1-4 are used to provide example structures for performing the steps of the process 500.

A connection is made by a test development device to a source device (502). As an example, the test development device 102 can be connected to the source device 104, such as by a cable connected to both devices. In some implementations, connecting to the source device can include connecting (e.g., over the network 106 or another wired or wireless connection) to a mobile device that is executing a mobile application, such as at a remote location (e.g., under operation by a separate user, different from the user viewing the development user interface 207).

User interactions with various components of an application executing at the source device are detected by the test development device (504). For example, the test development device 102 can detect the user interactions 210 that are coming from the source device 104 during testing of the application 202.

A p_method corresponding to each user interaction with the various components of the application is identified, by the test development device, within code of the application or underlying OS framework code (506). As an example, the test development device 102 can determine, from the components 204a and 204b, the corresponding p_methods 206a and 206b that handle the user interactions. The p_method can be anywhere in the software stack, e.g., within the tested application's code or in underlying OS framework code.

Contextual information is extracted from each identified p_method that corresponding to the component with which the user interaction occurred (508). For example, during the test, the test development device 102 can extract information associated with text that is entered, clicks that are made, and other actions.

In some implementations, the process 500 uses a breakpoint inserted into the application to extract the contextual information, such as using the following actions performed by the test development device 102. For example, within the code of the application or underlying OS framework, a target p_method can be identified that corresponds to a target user interaction to be tracked. A first line of the target p_method within the code of the application or underlying OS framework code can be identified. A line breakpoint can be inserted into the code of the target p_method based on the identified first line of the target p_method. In some implementations, identifying the p_method corresponding to each user interaction with the various components of the application can include processing the line breakpoint during execution of the application at the source device 104. In some implementations, extracting contextual information comprises extracting, after processing the line breakpoint, one or more attributes of the target p_method. For example, the attributes can include user interface elements (e.g., field names) being acted upon, a type of interaction (e.g., typing, selecting/clicking, hovering, etc.).

A test script is generated by the test development device based on the user interactions and the contextual information extracted from the identified p_methods (510). As an example, the test script 302 can be generated by the test development device 102 based on the user interactions 210.

The test script is automatically run on a test device that differs from the source device (512). For example, using devices/platforms or other test targets specified on the test script launcher 402, the test script 302 can be run on specific test devices 114.

In some implementations, use of the test development device 102 can include none, some, or all of the following actions. A control can be clicked or selected to initiate test recording. A device can be selected from a list of available devices and emulators, such as a test device connected to the test development device 102 (e.g., a laptop computer) or a device available through the network 106 (e.g., in the cloud). A display can be initiated that simulates the display controls on the test device. A scenario can be followed, including a sequence of test steps, for the application being tested on the test device. Optionally, assertions can be added to assure that certain elements are correctly presented on the screen. Recording of the test can be stopped, which initiates automatic generation and completion of the test case, e.g., the test script 302. Optionally, the test case is inspected, e.g., by a user using the development user interface 207. The test case can then be run on other devices immediately or at a later time. On a test run basis, test results can be presented that indicate that the test has completed successfully, or if the test case has failed, information can be presented that is associated with the failure.

In some implementations, the process 500 includes steps for using a display for simulating testing, e.g., on the source device 104. For example, a test simulation display (e.g., the source device simulation 209) can be provided on a display of the test development device 102 (e.g., the development user interface 207) that replicates and simulates testing on a user interface of the source device. User interactions with the various components of the application (e.g., the user interactions 210) can be presented within the test simulation display, e.g., based on or corresponding to the generated test script (e.g., as actual user interactions occur on the source device 104).

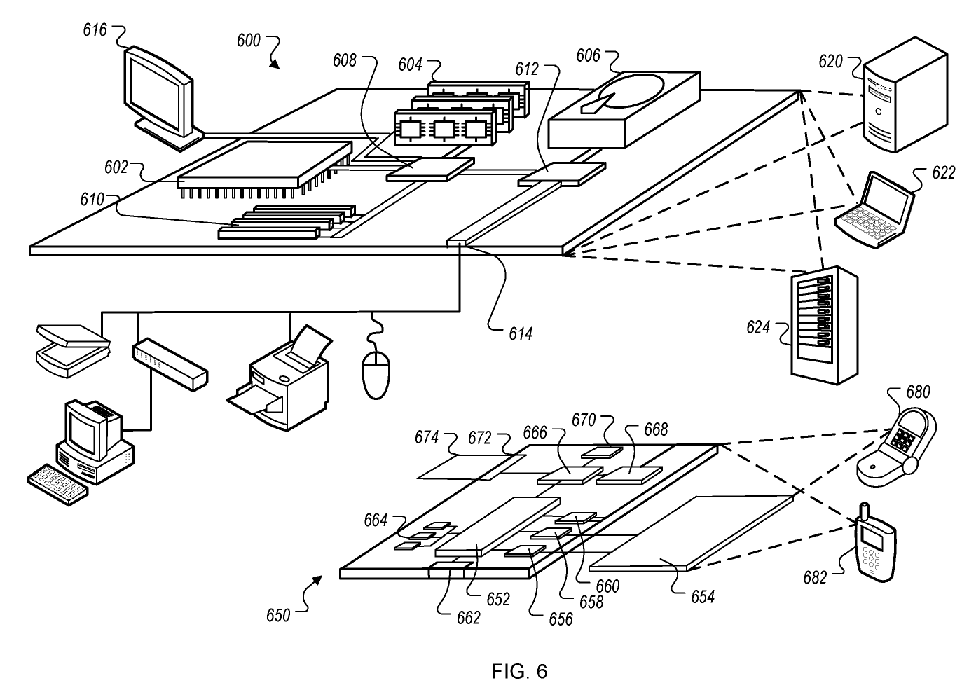

FIG. 6 is a block diagram of example computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 600 is further intended to represent any other typically non-mobile devices, such as televisions or other electronic devices with one or more processers embedded therein or attached thereto. Computing device 650 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document. Some aspects of the use of the computing devices 600, 650 and execution of the systems and methods described in this document may occur in substantially real time, e.g., in situations in which a request is received, processing occurs, and information is provided in response to the request (e.g., within a few seconds or less). This can result in providing requested information in a fast and automatic way, e.g., without manual calculations or human intervention. The information may be provided, for example, online (e.g., on a web page) or through a mobile computing device.

Computing device 600 includes a processor 602, memory 604, a storage device 606, a high-speed controller 608 connecting to memory 604 and high-speed expansion ports 610, and a low-speed controller 612 connecting to low-speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high-speed controller 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low-speed controller 612 manages lower bandwidth-intensive operations. Such allocation of duties is an example only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed bus 614. The low-speed bus 614 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as computing device 650. Each of such devices may contain one or more of computing devices 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The computing device 650 may also be provided with a storage device, such as a micro-drive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the computing device 650, such as control of user interfaces, applications run by computing device 650, and wireless communication by computing device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of computing device 650 with other devices. External interface 662 may provide, for example, for wired communication (e.g., via a docking procedure) or for wireless communication (e.g., via Bluetooth® or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to computing device 650 through expansion interface 672, which may include, for example, a subscriber identification module (SIM) card interface. Such expansion memory 674 may provide extra storage space for computing device 650, or may also store applications or other information for computing device 650. Specifically, expansion memory 674 may include instructions to carry out or supplement the processes described above, and may include secure information also. Thus, for example, expansion memory 674 may be provide as a security module for computing device 650, and may be programmed with instructions that permit secure use of computing device 650. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Computing device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 668 (e.g., a radio-frequency transceiver). In addition, short-range communication may occur, such as using a Bluetooth®, WiFi, or other such transceiver (not shown). In addition, GPS receiver module 670 may provide additional wireless data to computing device 650, which may be used as appropriate by applications running on computing device 650.

Computing device 650 may also communicate audibly using audio codec 660, which may receive spoken information from a user and convert it to usable digital information. Audio codec 660 may likewise generate audible sound for a user, such as through a speaker, e.g., in a handset of computing device 650. Such sound may include sound from voice telephone calls, may include recorded sound (e.g., voice messages, music files, etc.) and may also include sound generated by applications operating on computing device 650.

The computing device 650 may be implemented in a number of different forms, as shown in the figure. For example, it may be implemented as a cellular telephone 680. It may also be implemented as part of a smartphone 682, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
connecting, by a test development device, to a source device;
detecting, by the test development device, user interactions with various components of an application executing at the source device;
identifying, by the test development device and within code of the application or underlying OS framework code, a p_method corresponding to each user interaction with the various components of the application;
extracting, from each identified p_method, contextual information corresponding to the component with which the user interaction occurred;
generating, by the test development device, a test script based on the user interactions and the contextual information extracted from the identified p_methods; and
automatically running the test script on a test device that differs from the source device.

2. The method of claim 1, wherein connecting to the source device comprises connecting to a mobile device that is executing a mobile application.

3. The method of claim 1, further comprising:
identifying, within the code of the application or underlying OS framework, a target p_method corresponding to a target user interaction to be tracked;
identifying a first line of the target p_method within the code of the application or underlying OS framework; and
inserting a line breakpoint into the code of the target p_method based on the identified first line of the target p_method.

4. The method of claim 3, wherein identifying a p_method corresponding to each user interaction with the various components of the application comprises processing the line breakpoint during execution of the application at the source device.

5. The method of claim 4, wherein extracting contextual information comprises extracting, after processing the line breakpoint, one or more attributes of the target p_method.

6. The method of claim 1, further comprising:
providing, on a display of the test development device, a test simulation display that replicates and simulates testing on a user interface of the source device; and
presenting, within the test simulation display, the user interactions with the various components of the application.

7. The method of claim 6, further comprising presenting, within the test simulation display, a list of the user interactions with the various components of the application, wherein the list of user interactions is generated based on the test script.

8. A non-transitory computer storage medium encoded with instructions that when executed by a distributed computing system cause the distributed computing system to perform operations comprising:
connecting, by a test development device, to a source device;
detecting, by the test development device, user interactions with various components of an application executing at the source device;
identifying, by the test development device and within code of the application or underlying OS framework code, a p_method corresponding to each user interaction with the various components of the application;
extracting, from each identified p_method, contextual information corresponding to the component with which the user interaction occurred;
generating, by the test development device, a test script based on the user interactions and the contextual information extracted from the identified p_methods; and
automatically running the test script on a test device that differs from the source device.

9. The non-transitory computer storage medium of claim 8, wherein connecting to the source device comprises connecting to a mobile device that is executing a mobile application.

10. The non-transitory computer storage medium of claim 8, the operations further comprising:
identifying, within the code of the application or underlying OS framework, a target p_method corresponding to a target user interaction to be tracked;
identifying a first line of the target p_method within the code of the application or underlying OS framework; and
inserting a line breakpoint into the code of the target p_method based on the identified first line of the target p_method.

11. The non-transitory computer storage medium of claim 10, wherein identifying a p_method corresponding to each user interaction with the various components of the application comprises processing the line breakpoint during execution of the application at the source device.

12. The non-transitory computer storage medium of claim 11, wherein extracting contextual information comprises extracting, after processing the line breakpoint, one or more attributes of the target p_method.

13. The non-transitory computer storage medium of claim 8, the operations further comprising:
providing, on a display of the test development device, a test simulation display that replicates and simulates testing on a user interface of the source device; and
presenting, within the test simulation display, the user interactions with the various components of the application.

14. The non-transitory computer storage medium of claim 8, the operations further comprising presenting, within the test simulation display, a list of the user interactions with the various components of the application, wherein the list of user interactions is generated based on the test script.

15. A system comprising:
one or more processors; and
one or more memory devices including instructions that, when executed, cause the one or more processors to:
connect, by a test development device, to a source device;
detect, by the test development device, user interactions with various components of an application executing at the source device;
identify, by the test development device and within code of the application or underlying OS framework code, a p_method corresponding to each user interaction with the various components of the application;
extract, from each identified p_method, contextual information corresponding to the component with which the user interaction occurred;
generate, by the test development device, a test script based on the user interactions and the contextual information extracted from the identified p_methods; and
automatically run the test script on a test device that differs from the source device.

16. The system of claim 15, wherein connecting to the source device comprises connecting to a mobile device that is executing a mobile application.

17. The system of claim 15, further including instructions that cause the one or more processors to:
identify, within the code of the application or the underlying OS framework, a target p_method corresponding to a target user interaction to be tracked;
identify a first line of the target p_method within the code of the application or underlying OS framework; and
insert a line breakpoint into the code of the target p_method based on the identified first line of the target p_method.

18. The system of claim 17, wherein identifying a p_method corresponding to each user interaction with the various components of the application comprises processing the line breakpoint during execution of the application at the source device.

19. The system of claim 18, wherein extracting contextual information comprises extracting, after processing the line breakpoint, one or more attributes of the target p_method.

20. The system of claim 15, further including instructions that cause the one or more processors to:
provide, on a display of the test development device, a test simulation display that replicates and simulates testing on a user interface of the source device; and
present, within the test simulation display, the user interactions with the various components of the application.
